(19) United States
(12) Patent Application Publication
(10) Pub. No.: US 2024/0214337 A1
(43) Pub. Date: Jun. 27, 2024

(54) GENERATION SYSTEM AND GENERATION PROGRAM

(71) Applicant: iUM inc., Tokyo (JP)

(72) Inventor: Daishi Fujikawa, Tokyo (JP)

(21) Appl. No.: 18/424,137

(22) Filed: Jan. 26, 2024

Related U.S. Application Data
(63) Continuation-in-part of application No. PCT/JP2022/023125, filed on Jun. 8, 2022.

(30) Foreign Application Priority Data
Jul. 28, 2021 (JP) 2021-122928

(51) Int. Cl. H04L 51/10; H04L 51/066

(52) U.S. Cl. CPC H04L 51/10; H04L 51/066

(57) ABSTRACT

Provided are a generation system and a generation program capable of easily creating a message letter. A server device (2) for generating a message letter displaying a message to a recipient from a plurality of target persons, includes: an acquisition unit (231) acquiring message information from the plurality of target persons, the message information indicating the message to the recipient; and an administration unit (232) generating message letter information indicating the message letter, on the basis of the message information acquired by the acquisition unit (231), in which the acquisition unit (231) performs: first processing of displaying a question for inputting the message as an answer on a side of the plurality of target persons; and second processing of acquiring answer information indicating the answer to the question, the answer being input to the generation system by the plurality of target persons, as the message information.

### CROSS REFERENCE TO RELATED APPLICATIONS

The present application claims the benefit of Japanese Patent Applications No. 2021-122928, filed on Jul. 28, 2021, the disclosure of which is incorporated by reference its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### TECHNICAL FIELD

The present invention relates to a generation system and a generation program.

### BACKGROUND ART

In the related art, a technology for providing a message letter is known (for example, refer to Patent Document 1).

### CITATION LIST

### Patent Document

Patent Document 1: Japanese Unexamined Patent Application Publication No. 2015-133000

### SUMMARY OF THE INVENTION

### Technical Problem

However, in the case of providing a message letter, it is necessary to write a message to a recipient, which may be a burden to consider the contents of the message to be written, and there has been a demand for a technology for easily creating a message letter.

It is an object of the present invention to solve the problems of the above mentioned prior arts.

### Solution to Problem

One aspect of the present invention provides is a generation system for generating a message letter displaying a message to a recipient from a plurality of target persons, the system comprising: an acquisition unit acquiring message information from the plurality of target persons, the message information indicating the message to the recipient; and an administration unit generating message letter information indicating the message letter, on the basis of the message information acquired by the acquisition unit, wherein the acquisition unit performs: first processing of displaying a question for inputting the message to the recipient as an answer on a side of the plurality of target persons; and second processing of acquiring answer information indicating the answer to the question displayed by the first processing, the answer being input to the generation system by the plurality of target persons, as the message information.

Another aspect of the present invention provides a generation program for generating a message letter displaying a message to a recipient from a plurality of target persons, the program allowing a computer to function as: an acquisition unit acquiring message information from the plurality of target persons, the message information indicating the message to the recipient; and an administration unit generating message letter information indicating the message letter, on the basis of the message information acquired by the acquisition unit, wherein the acquisition unit performs: first processing of displaying a question for inputting the message to the recipient as an answer on a side of the plurality of target persons; and second processing of acquiring answer information indicating the answer to the question displayed by the first processing, the answer being input to the computer by the plurality of target persons, as the message information.

### BRIEF DESCRIPTION OF THE DRAWINGS

FIG. 1 is a display example of a page in a message letter of this embodiment.

FIG. 2 is a display example of a page in a message letter of this embodiment.

FIG. 3 is a display example of a page in a message letter of this embodiment.

FIG. 4 is an enlarged view of a part of FIG. 3.

FIG. 5 is a block diagram functionally and conceptionally illustrating an information processing system.

FIG. 6 is a diagram exemplifying member information.

FIG. 7 is a diagram exemplifying question related information.

FIG. 8 is a diagram exemplifying setting information.

FIG. 9 is a diagram exemplifying a design of a message letter.

FIG. 10 is a diagram exemplifying answer related information.

FIG. 11 is a diagram exemplifying browsing related information.

FIG. 12 is a flowchart of organizer related processing.

FIG. 13 is a flowchart of setting information storage processing.

FIG. 14 is a display example of a screen for inputting setting information.

FIG. 15 is a display example of a screen for inputting setting information.

FIG. 16 is a display example of a screen for inputting answer related information.

FIG. 17 is a display example of a screen for inputting answer related information.

FIG. 18 is a flowchart of participant related processing.

FIG. 19 is a flowchart of provision processing.

FIG. 20 is a display example of an administration screen.

### MODE FOR CARRYING OUT THE INVENTION

Hereinafter, an embodiment of a generation system and a generation program according to the invention will be described in detail, with reference to the attached drawings.

### [I] Basic Concept of Embodiment

First, the basic concept of the embodiment will be described. The embodiment relates to a generation system and a generation program. The generation system according to the invention is a system for generating a message letter displaying a message to a recipient from a plurality of target persons.

The “message letter” displays the message from the plurality of target persons, and for example, is a concept including a message letter in a booklet format including a plurality of pages, a message letter including only one page, and the like. The format of such a message letter is any format, and for example, may be the format of a bound booklet, a downloadable file in a predetermined format, or browsable information that can be browsed (as an example, information corresponding to a web page that can be browsed by a web browser, and the like).

The “target person” is a person who considers each message of the message letter, that is, is a concept including a person who sends a message, and the like. The “recipient” is a person to whom each message of the message letter is sent, that is, is a concept including a person to whom the message letter is sent, and the like.

Then, in the following embodiment, a case will be described in which the “message letter” is in a booklet format including a plurality of pages.

### [II] Specific Contents of Embodiment

Next, specific contents of the embodiment will be described.

### Message Letter

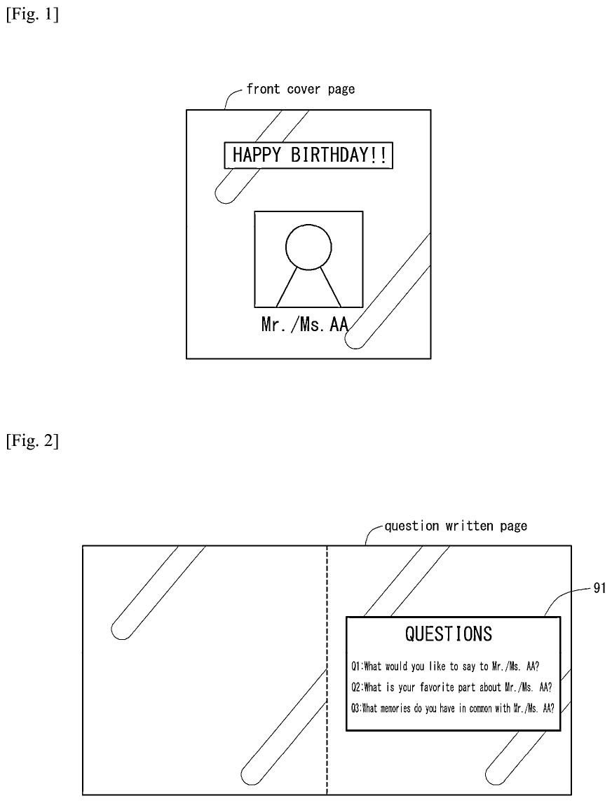

First, the message letter of this embodiment will be described. FIG. 1 to FIG. 3 are display examples of a page in the message letter of this embodiment.

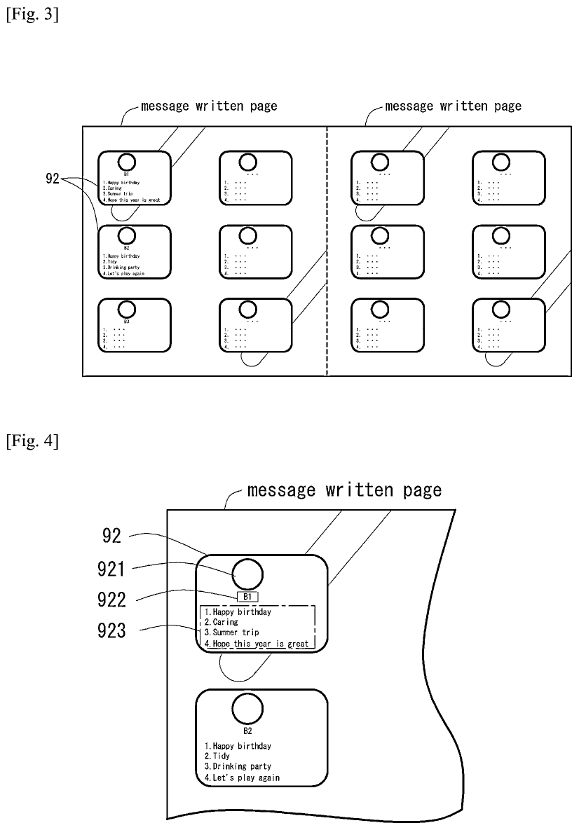

The message letter of this embodiment, for example, is a message letter in a booklet format including a plurality of pages including a front cover page in FIG. 1, a question written page in FIG. 2, and a message written page in FIG. 3 and the like.

### Message Letter-Front Cover Page

The front cover page in FIG. 1 is a page corresponding to the front cover of the message letter in the booklet format, and for example, is a page on which a title corresponding to the type of message letter (“HAPPY BIRTHDAY!!” corresponding to “Birthday”), a photographic image indicating the recipient (the image of a rectangular portion in FIG. 1), the name of the recipient (“Mr./Ms. AA”), and the like are displayed.

### Message Letter-Question Written Page

The question written page in FIG. 2 is a page on which a question to the target person is displayed, and for example, is a page including an in-booklet question display field 91. The in-booklet question display field 91 is a field in which a question for inputting the message to the recipient as an answer is displayed.

### Message Letter-Message Written Page

The message written page in FIG. 3 is a page on which the message to the recipient is displayed, and for example, is a page including a plurality of in-booklet individual message fields 92. FIG. 4 is an enlarged view of a part of FIG. 3.

The in-booklet individual message field 92 is a field in which the message of each target person is displayed, and as illustrated in FIG. 4, for example, includes an image display field 921, a name display field 922, and a message display field 923.

The image display field 921 is a field for displaying an image indicating the target person (for example, a photographic image of the face of the target person, a portrait image, any image associated with a target person, or the like). The name display field 922 is a field for displaying the name (for example, a real name, a nickname, or the like) of the target person. The message display field 923 is a field for displaying the message to the recipient from the target person.

### Configuration

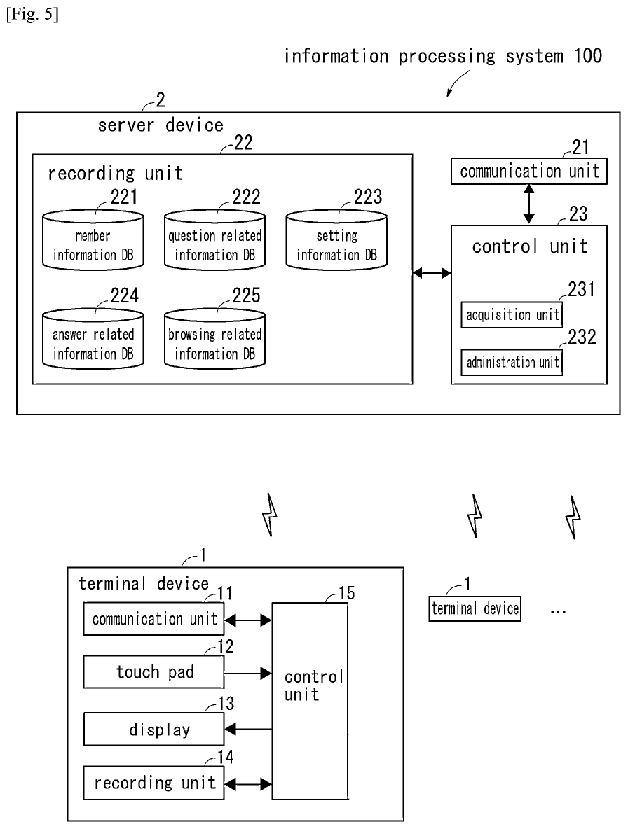

Next, the configuration of an information processing system will be described. FIG. 5 is a block diagram functionally and conceptionally illustrating the information processing system. An information processing system 100, for example, includes a plurality of terminal devices 1, and a server device 2, and such devices are capable of communicating with each other. Note that, in the information processing system 100, the plurality of terminal devices 1 carried by various users (for example, an organizer, a participant, the recipient described above, and the like) are included.

Note that, the “organizer” is a concept indicating a person in charge of organizing the message letter, and for example, is an administrator administering the message letter, and is a concept including a person suitably performing entry, input, or the like, in consideration of the message to the recipient. The “participant” is a concept indicating a person participating in the message letter, and for example, is a concept including a person suitably performing entry, input, or the like, in consideration of the message to the recipient.

Note that, in this embodiment, since both of the organizer and the participant suitably perform entry or input in consideration of the message to the recipient, the following description will be made on the assumption that both of the organizer and the participant correspond to the “target person”.

### Configuration-Terminal Device

The terminal device 1 in FIG. 5 is a device carried by a user, and for example, is a tablet terminal or a smart phone, and includes a communication unit 11, a touch pad 12, a display 13, a recording unit 14, and a control unit 15, as an example. Note that, as the terminal device 1, for example, a personal computer may be applied.

The communication unit 11 is a communication unit performing communication with respect to the external device (for example, the server device 2). The touch pad 12 is a manipulation unit receiving various manipulation inputs from the user. The display 13 is an image display unit displaying various images, and for example, the touch pad 12 and the display 13 are integrally formed as a touch panel. The recording unit 14 is a recording unit recording programs and various data pieces. The control unit 15 is a control unit controlling the terminal device 1, and for example, is configured by using an internal memory such as a CPU, a RAM, a ROM, and the like.

### Configuration-Server Device

The server device 2 is the generation system described above, and for example, includes a communication unit 21, a recording unit 22, and a control unit 23.

### Configuration-Server Device-Communication Unit

The communication unit 21 in FIG. 5 is a communication unit performing communication with respect to the external device (for example, the terminal device 1).

### Configuration-Server Device-Recording Unit

The recording unit 22 in FIG. 5 is a recording unit recording programs and various data pieces required for the operation of the server device 2. The recording unit 22, for example, includes a member information database 221 (hereinafter, the database will be referred to as “DB”), a question related information DB 222, a setting information DB 223, an answer related information DB 224, and a browsing related information DB 225.

### Configuration-Server Device-Recording Unit-Member Information DB

The member information DB 221 in FIG. 5 is a member information storage unit storing member information.

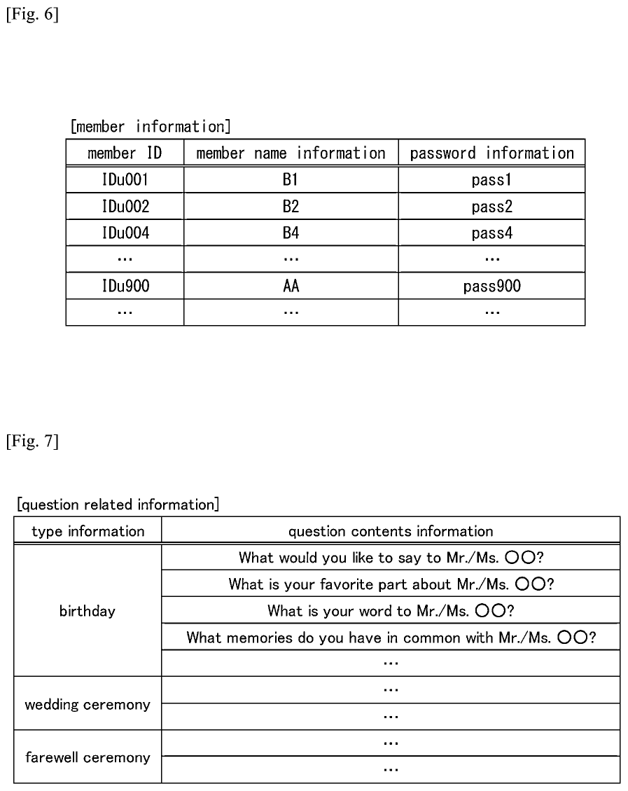

FIG. 6 is a diagram exemplifying the member information. The “member information” is information for specifying a member of a service applied by the information processing system 100, and for example, the information of each item illustrated in FIG. 6 is associated with each other.

A member ID in FIG. 6 is member identification information for uniquely identifying the member (hereinafter, the identification information will be also referred to as “ID”). Member name information in FIG. 6 is information indicating the name of the member (in FIG. 6, for convenience, “B1” or the like is illustrated). Password information in FIG. 6 is information indicating a password for authenticating the member.

Then, the uppermost information in FIG. 6, for example, indicates that the name of the member identified by “IDu001” is “B1”, and the password for authenticating the member is “pass1”. Note that, such member information is stored by inputting the information to the server device 2.

### Configuration-Server Device-Recording Unit-Question Related Information DB

The question related information DB 222 in FIG. 5 is a question related information storage unit storing question related information.

FIG. 7 is a diagram exemplifying the question related information. The “question related information” is information relevant to a pre-created question created in advance, and for example, the information of each item illustrated in FIG. 7 is associated with each other.

Type information in FIG. 7 is information indicating the type of message letter. Question contents information in FIG. 7 is information indicating the pre-created question for inputting the message to the recipient as an answer, the pre-created question being created in advance.

Then, FIG. 7 illustrates that the pre-created question belonging to “Birthday” type message letter is “What would you like to say to Mr./Ms. ○○?”, “What is your favorite part about Mr./Ms. ○○?”, and the like. Note that, such question related information is stored by inputting the information to the server device 2.

### Configuration-Server Device-Recording Unit-Setting Information DB

The setting information DB 223 in FIG. 5 is a setting information storage unit storing setting information.

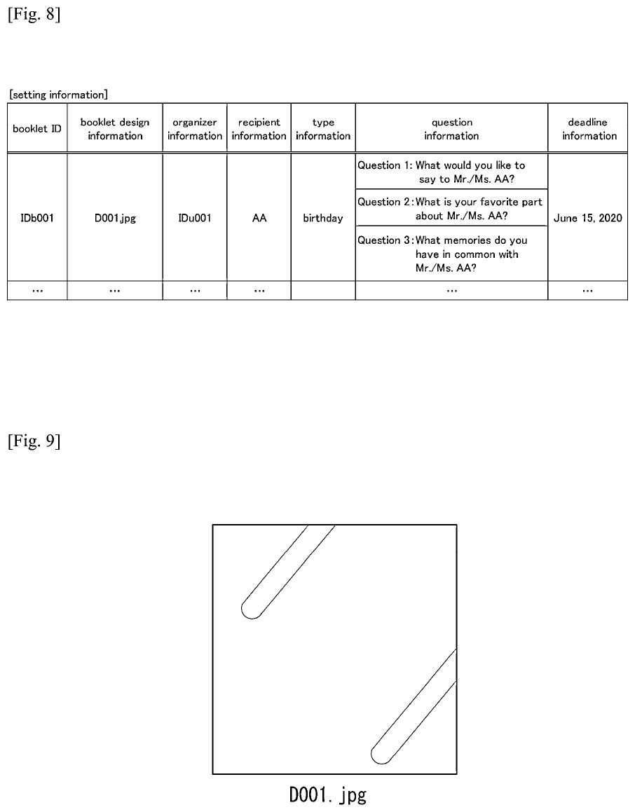

FIG. 8 is a diagram exemplifying the setting information. The “setting information” is information indicating basic setting, questions, and the like for generating the message letter, and for example, the information of each item illustrated in FIG. 8 is associated with each other.

A booklet ID in FIG. 8 is information for uniquely identifying the message letter in a booklet format. Booklet design information in FIG. 8 is information indicating the design of the message letter. FIG. 9 is a diagram exemplifying the design of the message letter. The “design of the message letter”, for example, is a concept indicating a sketch, a background color, or the like when displaying the message letter in a booklet format, and as an example, image information indicating the sketch illustrated in FIG. 9, or the like is used.

The organizer information in FIG. 8 is information indicating the organizer. Note that, in this application, a case will be described in which only the member can be the organizer, and the member ID in FIG. 6 is used as the organizer information. Recipient information in FIG. 8 is information indicating the recipient, and for example, information indicating the real name, the nickname, or the like of the recipient is used. Type information in FIG. 8 is the same as the information with the same name in FIG. 7. Question information in FIG. 8 is information indicating the question for inputting the message to the recipient as an answer. Deadline information in FIG. 8 is information indicating a deadline for the entry or the input of the message by the participant.

Then, FIG. 8 illustrates that the design of the message letter identified by “IDb001” is the design in FIG. 9 indicated by “D001.jpg”, and the organizer of the message letter is the member identified by “IDu001” (that is, “B1” in FIG. 6), illustrates that the recipient of the message letter is “AA”, and illustrates that the type of message letter is “Birthday”. In addition, FIG. 8 illustrates that for the message letter, there are three questions for inputting the message to the recipient as an answer, in which “Question 1” is “What would you like to say to Mr./Ms. AA?”, “Question 2” is “What is your favorite part about Mr./Ms. AA?”, and “Question 3” is “What memories do you have in common with Mr./Ms. AA?”. In addition, FIG. 8 illustrates that for the message letter, the deadline of the entry or the input of the message by the participant is “Jun. 15, 2020”.

Note that, such setting information is stored by executing setting information storage processing described below.

### Configuration-Server Device-Recording Unit-Answer Related Information DB

The answer related information DB 224 in FIG. 5 is an answer related information storage unit.

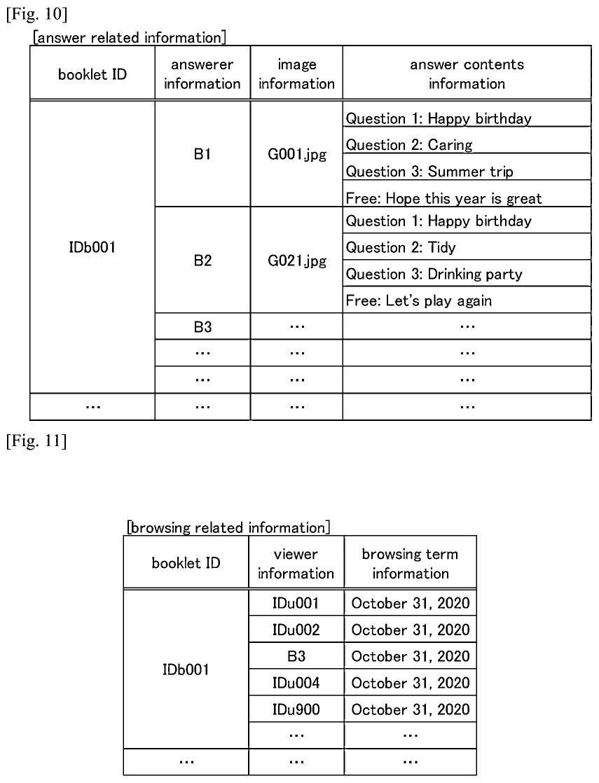

FIG. 10 is a diagram exemplifying the answer related information. The “answer related information” is information relevant to the answer to the question, and for example, the information of each item illustrated in FIG. 10 is associated with each other.

A booklet ID in FIG. 10 is the same as the information with the same name in FIG. 8. Answerer information in FIG. 10 is information indicating an answerer (that is, the target person). Image information in FIG. 10 is information indicating the image of the answerer (for example, the photographic image of the face of the target person, the portrait image, any image associated with the target person, or the like). Answer contents information in FIG. 10 is information indicating the contents of the answer of the answerer to the question (that is, the message to the recipient), or the like.

Then, FIG. 10 illustrates that the answerer of the message letter identified by “IDb001” is “B1”, illustrates that the image of “B1” is the image of “G001.jpg”, and illustrates that the answer of “B1” to “Question 1” is “Happy birthday”, the answer of “B1” to “Question 2” is “Caring”, the answer of “B1” to “Question 3” is “Summer trip”, and a free message of “B1” is “Hope this year is great”. Note that, the “free message” is a concept indicating the message to the recipient that is freely displayed in a format other than the answer to the question.

Note that, such answer related information is stored by executing organizer related processing and participant related processing described below.

### Configuration-Server Device-Recording Unit-Browsing Related Information DB

The browsing related information DB 225 in FIG. 5 is a browsing related information storage unit.

FIG. 11 is a diagram exemplifying the browsing related information. The “browsing related information” is information relevant to browsing in the case of providing the message letter as the browsable information that can be browsed, and for example, the information of each item illustrated in FIG. 11 is associated with each other.

A booklet ID in FIG. 11 is the same as the information with the same name in FIG. 8. Viewer information in FIG. 11 is information indicating a person browsing the message letter, and for example, the member ID in FIG. 6, the information indicating the name, or the like is used. Browsing term information in FIG. 11 is information indicating a browsing term that is a term for browsing.

Then, FIG. 11 illustrates that the viewer of the message letter identified by “IDb001” is the persons indicated by “IDu001”, “IDu002”, and the like, and the browsing term of each viewer is “Oct. 31, 2020”. That is, it is illustrated that each viewer is capable of browsing the message letter until “Oct. 31, 2020”.

Note that, such browsing related information is stored by performing provision processing and browsing term extension processing described below.

### Configuration-Server Device-Control Unit

The control unit 23 in FIG. 5 is a control unit controlling the server device 2, and for example, functionally and conceptionally includes an acquisition unit 231 and an administration unit 232. The acquisition unit 231 is an acquisition unit acquiring message information from the plurality of target persons, in which the message information indicates the message to the recipient. In addition, the acquisition unit 231 performs first processing of displaying the question for inputting the message to the recipient as an answer on the side of the plurality of target persons, and second processing of acquiring the answer information indicating the answer to the question displayed by the first processing, in which the answer is input to the generation system by the plurality of target persons, as the message information. The administration unit 232 is an administration unit generating message letter information indicating the message letter, on the basis of the message information acquired by the acquisition unit. Note that, the processing performed by each unit of the control unit 23 will be described below.

### Processing

Subsequently, the processing executed by the information processing system 100 according to this embodiment will be described. For example, the organizer related processing, the participant related processing, the provision processing, and the browsing term extension processing will be described.

Note that, here, a case will be described in which the “organizer” is “B1” that is a member in FIG. 6, the “participant” is “B2” that is a member and “B3” that is a non-member (that is, not a member), and the “recipient” is “AA” that is a member.

### Processing-Organizer Related Processing

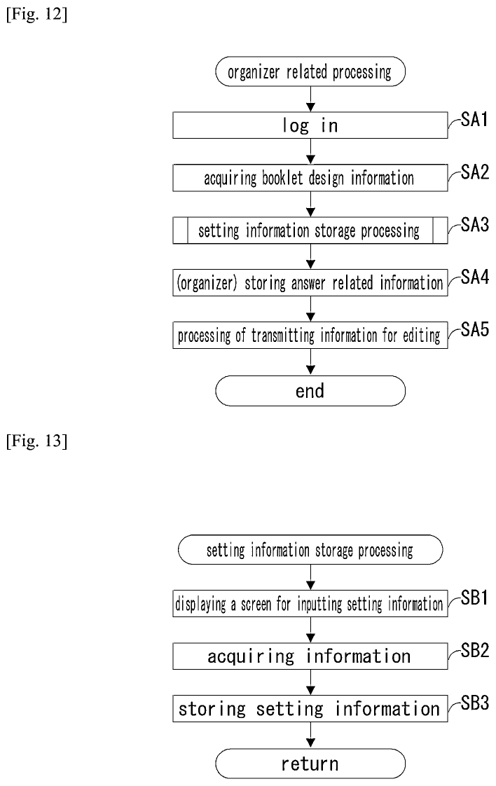

The organizer related processing will be described. FIG. 12 is a flowchart of the organizer related processing (in the description of each processing described below, step will be abbreviated as “S”). The organizer related processing is processing relevant to the organizer for the message letter, and for example, is processing that is executed by the server device 2.

It is assumed that the execution of the organizer related processing, for example, is started in a case where the user who is the member to be the organizer performs a predetermined manipulation for executing the organizer related processing through the own terminal device 1, and the description will be made from a point when the processing is started.

### SA1

In SA1 of FIG. 12, the control unit 23 of the server device 2 allows the user to log in.

For example, in a case where “B1” who is the user to be the organizer inputs “IDu001” and “pass1” that are the own member ID and the password information through the touch pad 12, the control unit 15 of the terminal device 1 transmits “IDu001” and “pass1” to the server device 2.

On the other hand, the control unit 23 of the server device 2 receives “IDu001” and “pass1” from the terminal device 1, and since the same combination of the member ID and the password information as “IDu001” and “pass1” is stored, the control unit 23 authenticates that the user is the member, with reference to the member information in FIG. 6, and allows the user to log in.

### SA2

In SA2 of FIG. 12, the control unit 23 of the server device 2 acquires booklet design information.

For example, information indicating a plurality of designs including the design in FIG. 9 is stored in the recording unit 22 of the server device 2. Then, the control unit 23 of the server device 2 generates screen information for displaying a screen for selecting a design to select a design that is adopted as the design of the message letter among the plurality of designs and transmits the screen information to the terminal device 1, and thus, displays the screen for selecting a design on the display 13 of the terminal device 1.

On the other hand, in a case where the user who is the organizer selects the design in FIG. 9 as the design of the message letter on the screen for selecting a design through the touch pad 12 of the terminal device 1, information indicating that the design in FIG. 9 is selected is transmitted to the server device 2, and the server device 2 receives the information, and acquires “D001.jpg” as the booklet design information indicating the design in FIG. 9 that indicates the received information.

### SA3

In SA3 of FIG. 12, the control unit 23 of the server device 2 executes the setting information storage processing. FIG. 13 is a flowchart of the setting information storage processing. The “setting information storage processing” is processing for storing the setting information.

### SB1

In SB1 of FIG. 13, the control unit 23 of the server device 2 displays a screen for inputting setting information.

### Screen for Inputting Setting Information

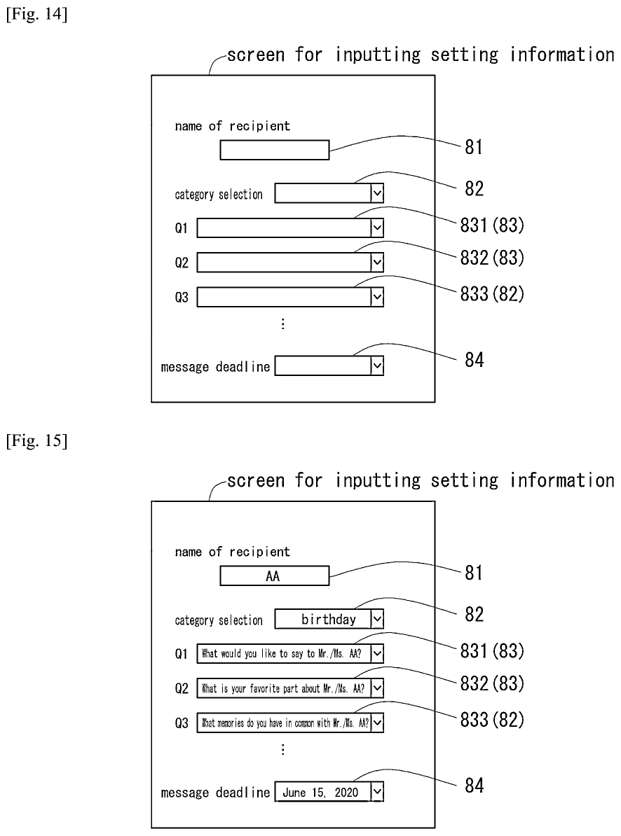

FIG. 14 and FIG. 15 are display examples of the screen for inputting setting information. The “screen for inputting setting information” is a screen for allowing the user to input the setting information, and for example, as illustrated in FIG. 14, includes a recipient name input field 81, a category input field 82, a question input field 83, and a deadline input field 84.

The recipient name input field 81 in FIG. 14 is a field to which the information indicating the name (for example, the real name, the nickname, or the like) of the recipient of the message letter is input. The category input field 82 is a field to which the information indicating the type of message letter is input. The question input field 83 is a field to which the information indicating the question for inputting the message of the message letter to the recipient as an answer is input. The deadline input field 84 is a field to which the information indicating the deadline of the entry or the input of the message by the participant is input.

### Question Input Field

The question input field 83 is configured such that the information indicating the pre-created question described above or an administrator-created question is input. The “administrator-created question” is a concept indicating a question created by the administrator (that is, the organizer) administering the generation of the message letter.

### Question Input Field-Input of Pre-Created Question

Specifically, for example, the category input field 82 is configured by using any method (for example, any method such as a method using a technology relevant to mouseover) such that in a case where the category input field 82 is tapped, “Birthday”, “Wedding ceremony”, and “Farewell ceremony”, which are the type information in the question related information of FIG. 7, are displayed as a list, and one type information piece in the displayed type information is selected by the user.

Here, for example, the description will be made on the assumption that “AA” is input to the recipient name input field 81. Then, in a case where “Birthday” is selected among “Birthday”, “Wedding ceremony”, and “Farewell ceremony”, which are displayed as a list when the category input field 82 in FIG. 14 is tapped by the user who is the organizer through the touch pad 12, the control unit 15 of the terminal device 1 transmits information indicating “Birthday” that is selected, and “AA” that is information input to the recipient name input field 81 to the server device 2.

On the other hand, the control unit 23 of the server device 2 specifies question contents information belonging to “Birthday” type information indicated by the information received from the terminal device 1, with reference to the question related information in FIG. 7, and selects a predetermined number (corresponding to the number of question input fields 83 in FIG. 14, and for example, three) of question contents information pieces among the specified question contents information. Note that, here, a selection method is any method, and for example, any three question contents information pieces may be selected by using a random function. Next, the control unit 23 of the server device 2 selects “What would you like to say to Mr./Ms. ○○?”, “What is your favorite part about Mr./Ms. ○○?”, and “What memories do you have in common with Mr./Ms. ○○?”, as three selected question contents information pieces, and replaces the “○○” portion of the selected question contents information pieces with “AA” received from the terminal device 1 to generate “What would you like to say to Mr./Ms. AA?”, “What is your favorite part about Mr./Ms. AA?”, and “What memories do you have in common with Mr./Ms. AA?”, as the question contents information, and transmits the generated question contents information to the terminal device 1, and thus, as illustrated in FIG. 15, inputs and displays the generated question contents information to question input fields 831 to 833.

As described above, in a case where the user inputs the information indicating the type of message letter to the category input field 82, information indicating a question corresponding to the input type may be automatically input and displayed to the question input field 83.

Note that, in a case where the question input field 83 is tapped, communication may be performed between the terminal device 1 and the server device 2, and the user may select and input information indicating a question corresponding to the other question contents information in the question related information of FIG. 7.

### Question Input Field-Administrator-Created Question

Specifically, for example, in a case where a manual input button (not illustrated) is displayed on the screen for inputting setting information, and the manual input button is tapped, an automatic input mode (a mode in which input is automatically performed as with the input of the pre-created question described above) may be switched to a manual input mode (for example, a mode in which the user is capable of freely inputting information), and information indicating a question created by the user may be input and displayed to the question input field 83 through the touch pad 12.

### Processing

The control unit 23 of the server device 2 generates screen information of a setting information input screen in FIG. 14 and transmits the screen information to the terminal device 1, and thus, displays the setting information input screen on the display 13 of the terminal device 1.

### SB2

In SB2 of FIG. 13, the control unit 23 of the server device 2 acquires information.

For example, in a case where the user who is the organizer inputs information to each input field through the touch pad 12, as illustrated in FIG. 15, and performs a predetermined manipulation (for example, a manipulation of tapping a “Save” button, which is not illustrated), the input information is transmitted to the server device 2 from the terminal device 1. On the other hand, the control unit 23 of the server device 2 receives and acquires the information transmitted from the terminal device 1.

### SB3

In SB3 of FIG. 13, the control unit 23 of the server device 2 stores the setting information.

For example, first, “IDb001” that is unique information is generated and stored as the booklet ID in FIG. 8. In addition, “D001.jpg” acquired in SA2 of FIG. 12 is stored as the booklet design information in FIG. 8. In addition, “IDu001” input at login in SA1 of FIG. 12 is stored as the organizer information in FIG. 8. In addition, “AA” input to the recipient name input field 81 in FIG. 15 acquired in SB2 of FIG. 13, “Birthday” input to the category input field 82, each information piece input to the question input field 83, and “Jun. 15, 2020” input to the deadline input field 84 are stored as the recipient information, the type information, the question information, and the deadline information in FIG. 8.

Specifically, for the question information, “What would you like to say to Mr./Ms. AA?” input to the question input field 831 corresponding to “Q1” in FIG. 15 is stored as “Question 1: What would you like to say to Mr./Ms. AA?” together with information such as “Question 1” indicating a question number. In addition, similar storage is performed for the information input to the question input fields 832 to 833 in FIG. 15. According to such processing, the setting information in FIG. 8 is stored. Then, returns the setting information storage processing.

### SA4

In SA4 of FIG. 12, the acquisition unit 231 of the server device 2 stores the answer related information. Specifically, a screen for inputting answer related information is displayed, information input to the screen for inputting answer related information is acquired, and the answer related information of the organizer who is the user is stored on the basis of the acquired information.

### Screen for Inputting Answer Related Information

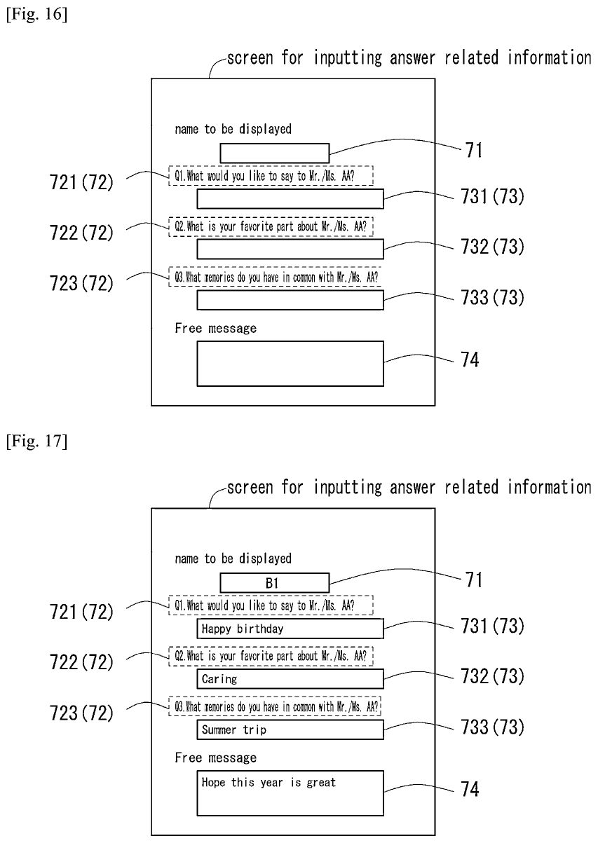

FIG. 16 and FIG. 17 are display examples of the screen for inputting answer related information. The “screen for inputting answer related information” is a screen for allowing the user to input the answer related information, and for example, as illustrated in FIG. 16, includes an answerer name input field 71, a question display field 72, an answer input field 73, and a free message input field 74.

The answerer name input field 71 in FIG. 16 is a field to which the information indicating the name (for example, the real name, the nickname, or the like) of a person answering to a question (that is, the target person) is input. The question display field 72 is a field in which the information indicating the question for inputting the message as an answer is displayed. The answer input field 73 is a field to which information indicating an answer to the corresponding question (that is, a message displayed on the message letter) is input. The free message input field 74 is a field to which information indicating the free message is input.

### Processing-Display of Screen for Inputting Answer Related Information

First, the acquisition unit 231 of the server device 2 specifies the question information associated with the booklet ID (“IDb001” stored in SB3 of FIG. 13) indicating the message letter to be processed, with reference to the setting information in FIG. 8, and generates screen information for displaying the answer related information input screen in FIG. 16 on which the specified question information is displayed in the question display field 72 to transmit the screen information to the terminal device 1, and thus, displays the setting information input screen on the display 13 of the terminal device 1.

Note that, here, processing is performed such that the question information of Question 1 to Question 3 is displayed in question display fields 721 to 723. In addition, here, the processing corresponds to the “first processing”.

### Processing-Acquisition of Information

Next, in a case where the user who is the organizer inputs information to each input field through the touch pad 12, as illustrated in FIG. 17, and performs a predetermined manipulation (for example, the manipulation of tapping the “Save” button, which is not illustrated), the input information is transmitted to the server device 2 from the terminal device 1. On the other hand, the acquisition unit 231 of the server device 2 receives and acquires the information transmitted from the terminal device 1.

Note that, here, it may be understood that the information input to the answer input field 73 in FIG. 17 corresponds to the “answer information” indicating the answer to the question, and the acquisition unit 231 of the server device 2 acquires the answer information as the message information indicating the message to the recipient. In addition, here, the processing corresponds to the “second processing”.

### Processing-Answer Related Information Storage

Next, the acquisition unit 231 of the server device 2 stores the answer related information, on the basis of the acquired information described above. For example, first, “IDb001” that is the booklet ID indicating the message letter to be processed is stored as the booklet ID in FIG. 10. In addition, “B1” input to the answerer name input field 71 in FIG. 17 acquired as described above, each information piece input to the answer input field 73, and the information input to the free message input field 74 are stored as the answerer information and the answer contents information in FIG. 10.

Specifically, for the answer contents information, “Happy birthday” input to an answer input field 731 corresponding to the question of “Q1” corresponding to the question display field in FIG. 17 is stored as “Question 1: Happy birthday” together with information such as “Question 1” indicating the question number. In addition, similar storage is performed for the information input to answer input fields 732 to 733 in FIG. 17. In addition, “Hope this year is great” input to the free message input field 74 in FIG. 17 is stored as “Free: Hope this year is great”, together with information such as “Free” indicating that it is a free message.

Note that, for the image information in FIG. 10, for example, a predetermined manipulation (for example, a manipulation of tapping an image registration button, which is not illustrated) is performed in the answer related information input field of FIG. 17, and thus, image information stored in the recording unit 14 of the terminal device 1 or image information captured by using a camera (not illustrated) of the terminal device 1 may be transmitted to the server device 2 side, and the transmitted image information may be acquired and stored by the acquisition unit 231 of the server device 2. According to such processing, information relevant to “B1” in the answer related information of FIG. 10 is stored.

### SA5

In SA5 of FIG. 12, the acquisition unit 231 of the server device 2 performs processing of transmitting information for editing. The “information for editing” is information for allowing the participant in the message letter to input or suitably edit the answer related information, and for example, a case will be described in which a URL for accessing a web page (hereinafter, referred to as a “web page for inputting information”) for inputting or suitably editing the information is used as the information for editing.

Here, for example, for the message letter of “booklet ID”=“IDb001” in which “B1” is the organizer, the acquisition unit 231 of the server device 2 generates a URL for inputting or suitably editing the answer related information, and transmits the URL to the participant side (that is, “B2” or the like who is the member and “B3” or the like who is the non-member). A specific transmission method is any method, and for example, the URL may be transmitted to the terminal device 1 carried by the participant through an e-mail, a predetermined communication application, a SNS, or the like.

Note that, in FIG. 12, for convenience of description, SA5 is executed after SA4, but the execution order may be reversed, or SA4 and SA5 may be simultaneously executed after SA3. With this, the organizer related processing is ended.

### Processing-Participant Related Processing

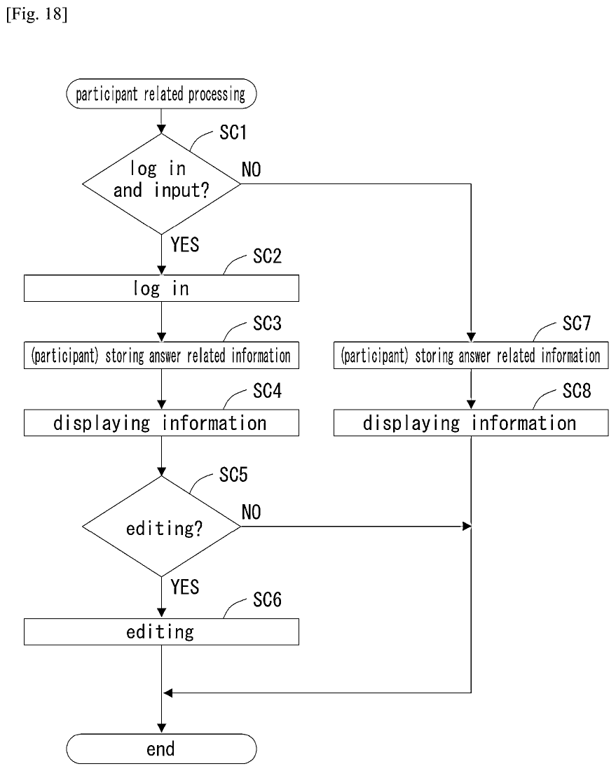

The participant related processing will be described. FIG. 18 is a flowchart of the participant related processing. The participant related processing is processing related to the participant for the message letter, and for example, is processing executed by the server device 2.

It is assumed that the execution of the participant related processing, for example, is started in the case of accessing the “web page for inputting information”, on the basis of the information for editing transmitted in SA5 of FIG. 12 (for example, a URL for accessing the “web page for inputting information” relevant to the message letter of “booklet ID”=“IDb001”), and the description will be made from a point when the processing is started. That is, a case will be described in which the booklet ID indicating the message letter to be processed is “IDb001”.

### SC1

In SC1 of FIG. 18, the acquisition unit 231 of the server device 2 determines whether to allow the user who is the participant to log in and input information or to allow the user to input information without login.

For example, the acquisition unit 231 of the server device 2 generates screen information for displaying a screen for selecting an input mode including a “Log in and Input” button and an “Input without Login” button, and transmits the screen information to the terminal device 1, and thus, displays the screen for selecting an input mode on the display 13 of the terminal device 1.

On the other hand, for example, in a case where “B2”, the participant who is the member, taps the “Log in and Input” button through the touch pad 12, the acquisition unit 231 of the server device 2 determines that the information is to be input by login (YES in SC1), and proceeds to SC2. In addition, for example, in a case where “B3”, the participant who is a non-member, taps the “Input without Login” button through the touch pad 12, the acquisition unit 231 of the server device 2 determines that the information is to be input without login (that is, the information is not input by login) (NO in SC1), and proceeds to SC7.

### SC2

In SC2 of FIG. 18, the acquisition unit 231 of the server device 2 allows the user to log in. Specifically, the same processing as SA1 in FIG. 12 is performed.

For example, in a case where “B2”, the participant who is the member, inputs “IDu002” and “pass2”, the acquisition unit 231 of the server device 2 authenticates that “B2” is the member, with reference to the member information in FIG. 6, and allows “B2” to log in.

### SC3===

In SC3 of FIG. 18, the acquisition unit 231 of the server device 2 stores the answer related information. Specifically, by performing the same processing as SA4 in FIG. 12, the screen for inputting answer related information is displayed, information input to the screen for inputting answer related information is acquired, and the answer related information of “B2” who is the participant is stored on the basis of the acquired information. Here, for example, information relevant to “B2” among the answer related information of FIG. 10 is stored.

### SC4

In SC4 of FIG. 18, the acquisition unit 231 of the server device 2 displays the answer related information stored in SC3. For example, in a case where “B2” who is the participant taps a “Preview” button (not illustrated) through the touch pad 12, the acquisition unit 231 of the server device 2 displays a preview screen for displaying the information stored in SC3 on the display 13 of the terminal device 1. In this case, “B2” who is the participant is capable of checking the information that “B2” itself inputs and stores by visually recognizing the preview screen.

### SC5

In SC5 of FIG. 18, the acquisition unit 231 of the server device 2 determines whether to edit the answer related information stored in SC3. For example, in a case where “B2” who is the participant taps an “Edit” button (not illustrated) through the touch pad 12, the acquisition unit 231 of the server device 2 determines that the editing is to be performed (YES in SC5), and proceeds to SC6. On the other hand, in a case where “B2” who is the participant does not tap the “Edit” button (not illustrated) through the touch pad 12 within a predetermined period of time, the acquisition unit 231 of the server device 2 determines that the editing is not to be performed (NO in SC5), and ends the processing.

### SC6

In SC6 of FIG. 18, the acquisition unit 231 of the server device 2 edits the answer related information stored in SC3. Specific processing is any processing, and for example, the screen for inputting answer related information in FIG. 17, on which each information piece stored in SC3 is reflected, is displayed on the terminal device 1, and edits the answer related information, on the basis of the information that is input to the screen for inputting answer related information from “B2” who is the participant. As described above, the participant “B2” who is the member is capable of storing the answer related information, and then, suitably editing the information.

### SC7

In SC7 after it is determined that “B3”, the participant who is the non-member, taps the “Input without Login” button, and the information is to be input without login (NO in SC1) in SC1 of FIG. 18, the answer related information is stored. Specifically, by performing the same processing as SA4 in FIG. 12, the screen for inputting answer related information is displayed, the information input to the screen for inputting answer related information is acquired, and the answer related information of “B3” who is the participant is stored on the basis of the acquired information. Here, for example, information relevant to “B3” (in FIG. 10, the display is partially omitted) among the answer related information in FIG. 10 is stored.

### SC8

In SC8 of FIG. 18, the acquisition unit 231 of the server device 2 displays the answer related information stored in SC7. For example, the same processing as SC4 is performed. In this case, “B3” who is the participant is capable of checking the information that “B3” itself inputs and stores by visually recognizing the preview screen. With this, the participant related processing is ended.

### Editing of Answer Related Information (Part 1)

In the participant related processing of FIG. 18, for the participant “B2” who is the member, since SC5 and SC6 are executed after the answer related information is stored in SC3, he/she is capable of suitably editing the information.

On the other hand, for the participant “B3” who is the non-member, since the processing such as SC5 and SC6 is not executed after the answer related information is stored in SC7, he/she is not capable of suitably editing the information. Here, for example, in the setting information of FIG. 8, by focusing on the case that the organizer information relevant to each message letter is stored, in a case where the login is performed as the organizer, the organizer is capable of freely editing the own answer related information or the answer related information of the other person. Then, in a case where the participant “B3” who is the non-member has a desire to edit the answer related information, “B1” who is the organizer may be requested to edit the answer related information with any method (for example, contact by telephone, e-mail, or the like), and “B1” that has received the request may edit the answer related information relevant to “B3” who is the non-member.

### Editing of Answer Related Information (Part 2)

In addition, for example, in a case where “B2”, the participant who is the member, accesses again the “web page for inputting information”, in a state where the answer related information in FIG. 10 is stored, by executing SC1 to SC6 in FIG. 18, since the answer related information is already stored after SC1 and SC2 are executed, SC4 to SC6 may be executed without executing SC3. Note that, in this case, the control unit 23 of the server device 2 may specify the current date, on the basis of the own timekeeping unit (for example, a timer or the like), and may specify “Jun. 15, 2020” that is the deadline information associated with “IDb001” that is the booklet ID indicating the message letter to be processed, with reference to the setting information in FIG. 8, and in a case where the current date is before “Jun. 15, 2020”, the “Edit” button (not illustrated) may be set to be tappable, whereas in a case where the current date is after “Jun. 15, 2020”, the “Edit” button (not illustrated) may be deleted not to be tappable. According to such a configuration, the answer related information is capable of being edited by the participant before the deadline, and the answer related information is not capable of being edited by the participant after the deadline.

### Processing-Provision Processing

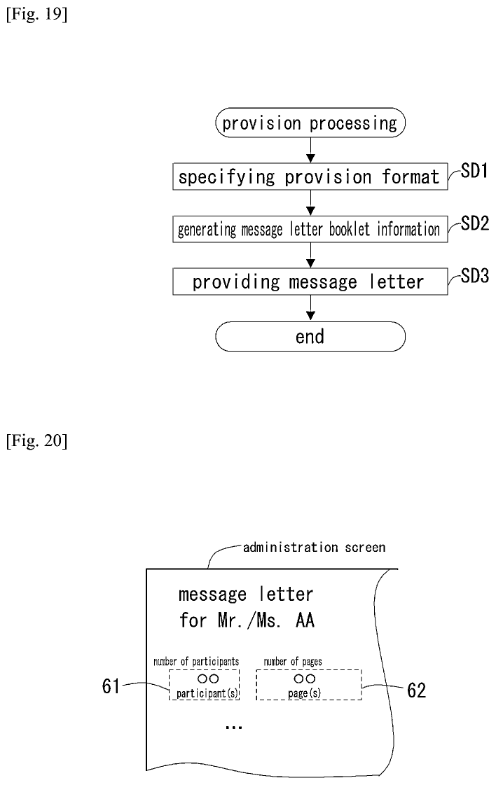

The provision processing will be described. FIG. 19 is a flowchart of the provision processing. The provision processing is processing for providing the message letter to a receiver, and for example, is processing executed by the server device 2.

It is assumed that the execution of the provision processing, for example, is started in a case where the user who is the organizer performs a predetermined manipulation for executing the provision processing through the touch pad 12 after the deadline, and the description will be made from a point when the processing is started. Here, for example, a case will be described in which the message letter identified by “booklet ID”=“IDb001” is provided.

### SD1

In SD1 of FIG. 19, the administration unit 232 of the server device 2 specifies a provision format for providing the message letter.

For example, the user who is the organizer inputs format designation information for designating any one or two or more formats of the format of the bound booklet (hereinafter, referred to as a “binding format”), the downloadable file in the predetermined format (hereinafter, referred to as a “file format”), and the format of the browsable information that can be browsed (as an example, the information corresponding to the web page that can be browsed by the web browser, and the like) (hereinafter, referred to as a “web page format”) through the touch pad 12, in accordance with a demand from the other user (for example, the participant or the recipient).

In this case, the input format designation information is transmitted to the server device 2 from the terminal device 1, and the administration unit 232 of the server device 2 receives the format designation information, and specifies the format designated by the received format designation information, as the provision format of the message letter.

### SD2

In SD2 of FIG. 19, the administration unit 232 of the server device 2 generates message letter booklet information. The “message letter booklet information” is the message letter information indicating the message letter, and for example, is information for generating the message letter in the booklet format illustrated in FIG. 1 to FIG. 4.

For example, the administration unit 232 of the server device 2 acquires each information associated with “IDb001” that is the booklet ID for identifying the message letter to be provided, with reference to the setting information in FIG. 8 and the answer related information in FIG. 10, and generates the message letter booklet information indicating the message letter in the booklet format illustrated in FIG. 1 to FIG. 4, on the basis of each acquired information.

Specifically, in the message letter in the booklet format of the design of “D001.jpg” that is the booklet design information in FIG. 8, the message letter booklet information for displaying “Birthday” that is the type information and information corresponding to “AA” who is the recipient information in FIG. 8, as the title and the name of the recipient in FIG. 1, displaying information corresponding to the question information in FIG. 8, as the information of the in-booklet question display field 91 in FIG. 2, and displaying information corresponding to the answerer information, the image information, and the answer contents information in FIG. 10, as the information of the in-booklet individual message field 92 in FIG. 3, is generated.

The message letter booklet information for displaying the information corresponding to the image information, the answerer information, and the answer contents information in FIG. 10, as the information of the in-booklet individual message field 92 in FIG. 3, more specifically, as the information of the image display field 921, the name display field 922, and the message display field 923 in FIG. 4, is generated.

Note that, here, the user who is the organizer is capable of arbitrarily editing the message letter booklet information through the own terminal device 1. Accordingly, the user who is the organizer, for example, is capable of making a minor adjustment on the arrangement of the information displayed on the message letter, correcting an error in each message, changing the title of the front cover page, or selecting and reflecting the photographic image indicating the recipient.

### SD3

In SD3 of FIG. 19, the administration unit 232 of the server device 2 provides the message letter in the provision format specified in SD1, on the basis of the message letter booklet information generated in SD2.

### Binding Format

In a case where the binding format is specified in SD1, the administration unit 232 of the server device 2 performs processing for binding the message letter in the booklet format illustrated in FIG. 1 to FIG. 4 and providing the bound message letter to the receiver. For example, the bound message letter may be provided to the receiver by transmitting the message letter booklet information generated in SB2, information indicating the address of the receiver as information indicating the destination of the message letter to the bookbinder side.

### File Format

In a case where the file format is specified in SD1, the administration unit 232 of the server device 2 converts the message letter booklet information generated in SD2, which indicates the message letter in the booklet format illustrated in FIG. 1 to FIG. 4, to a file in a predetermined format (for example, a PDF format or the like), and then, stores the converted information in a server device for distribution (not illustrated). Then, information, for downloading the stored message letter booklet information in the predetermined format, that indicates an access destination to the server device for distribution (for example, a URL) is transmitted to the receiver side through an e-mail, a predetermined communication application, a SNS, or the like. As described above, the message letter is provided as the downloadable file in the predetermined format.

### Web Page Format

In a case where the web page format is specified in SD1, the administration unit 232 of the server device 2 generates a web page including a plurality of pages for displaying the message letter illustrated in FIG. 1 to FIG. 4 in a booklet format, on the basis of the message letter booklet information generated in SD2, and transmits information for accessing and browsing the web page (for example, URL) (hereinafter, referred to as “access information”) to the receiver side through an e-mail, a predetermined communication application, a SNS, or the like. As described above, the message letter is provided as the browsable information that can be browsed.

Note that, in a case where the message letter is provided as the web page that can be browsed, the administration unit 232 of the server device 2 sets the browsing term for each receiver, and performs processing such that browsing is available before the browsing term, and browsing is not available after the browsing term.

For example, a case will be described in which the receiver is “B1”, “B2”, “B3”, “B4”, “AA”, and the like. In a case where the access information to the web page for displaying the message letter illustrated in FIG. 1 to FIG. 4 in the booklet format is provided to the receiver, in the browsing related information of FIG. 11, the administration unit 232 of the server device 2 stores “IDb001” for identifying the message letter to be a target, as the booklet ID, stores information indicating each provider, as the viewer information, and stores “Oct. 31, 2020” that is information indicating a date after a predetermined number of days from the current date, as the browsing term information.

Note that, as the viewer information in FIG. 11, the member ID in FIG. 6 (“IDu001” in FIG. 11, or the like) is stored for the member, and information input to the non-member (for example, the information indicating the name, or the like) (“B3” in FIG. 11) is stored for the non-member.

Then, in a case where the receiver tries to access the web page described above by using the own terminal device 1, on the basis of the “access information”, the administration unit 232 of the server device 2 causes the receiver to input information indicating him/herself (for example, the information indicating the member ID or the name), specifies the browsing term information associated with the input information, and specifies the current date, with reference to the browsing related information in FIG. 11, and then, in a case where the current date is a date before the date indicated by the browsing term information, the browsing of the web site is available (that is, the web site is displayed on the display 13), whereas in a case where the current date is after the date indicated by the browsing term information, the browsing of the web site is not available (that is, the web site is not displayed on the display 13). As described above, web site can be browsed only before the browsing term. With this, the provision processing is ended.

### Processing-Browsing Term Extension Processing

The browsing term extension processing will be described. The browsing term extension processing is processing for extending the browsing term, and for example, is processing executed by the server device 2.

For example, in a case where “B1” who is the receiver inputs “IDu001” as the information indicating him/herself through the touch pad 12, and performs a predetermined manipulation for requesting the extension of the browsing term (for example, the payment of additional fee for the extension, a manipulation for requesting the extension, and the like), the administration unit 232 of the server device 2 stores “Dec. 31, 2020” indicating a date after a predetermined period (for example, after two months) from the current browsing term, as the browsing term information associated with “IDu001” input as described above, with reference to the browsing related information in FIG. 11, and thus, extends the browsing term. With this, the browsing term extension processing is ended.

### Effects of This Embodiment

According to this embodiment, by displaying the question for inputting the message as an answer, and acquiring the answer information indicating the answer to the displayed question as the message information, for example, it is possible to consider the contents of the message in a format such as the answer to the question, and thus, it is possible to reduce a burden of considering the contents of the message, and it is possible to easily generate the message letter.

In addition, by displaying the pre-created question or the administrator-created question, for example, it is possible to display the question by reducing a burden of considering the question or to display the question by reflecting the intention of the administrator, and thus, it is possible to easily generate the message letter.

In addition, by displaying the pre-created question corresponding to the type of message letter, for example, it is possible to display a suitable question, and thus, it is possible to suitably generate the message letter.

In addition, by generating the message letter information indicating the message letter in the booklet format including the plurality of pages, for example, it is possible to generate the message letter in the booklet format, which is capable of suitably displaying a plurality of messages.

In addition, by performing the processing for providing the message letter to the receiver as the bound booklet, the downloadable file in the predetermined format, or the browsable information that can be browsed, for example, it is possible to provide the message letter in a format according to the needs of the receiver.

In addition, by extending the browsing term, on the basis of the request from the receiver, for example, it is possible to make the browsing available until a time desired by the receiver.

### [III] Modification Example of Embodiment

The embodiment according to the invention has been described, but the specific configuration and unit of the invention can be arbitrarily modified and improved within the scope of the technical idea of each invention described in the claims.

### Problems to be Solved and Effects of Invention

First, the problems to be solved by the invention and the effects of the invention are not limited to the contents described above, but may be different in accordance with the implementation environment of the invention and the details of the configuration, and only a part of the problems described above may be solved, or only a part of the effects described above may be attained.

### Distribution and Integration

In addition, the information of each DB may be distributed or integrated.

### Shape, Numerical Value, Structure, and Time Series

For the constituents exemplified in the embodiment and the drawings, the shapes, the numerical values, or the structures or the temporal relationships of a plurality of constituents can be arbitrarily modified and improved within the scope of the technical idea of the invention.

### Overall Display of Message Information

In addition, for the message letter described in the above embodiment, as illustrated in FIG. 3, messages for a predetermined number of persons (for example, six persons) are displayed on one page, but in addition to such a page, a list display page on which messages for persons (for example, 24 persons, or the like) more than the number of persons posted on the message written page are displayed as a list in a format different from that of the message written page may be included in the message letter. Note that, the list display page may be one page for displaying messages for all of the target persons, or may be a plurality of pages (for example, two facing pages, or the like).

### Receiver

In addition, the receiver of the message letter described in the above embodiment may be determined by the user who is the organizer, in accordance with a demand. In this case, for example, it may be determined that the receiver includes at least the recipient, and arbitrarily also includes the target person.

### Administration Screen (Part 1)

In addition, an administration screen may be displayed. FIG. 20 is a display example of the administration screen. The “administration screen” is a screen for the user who is the organizer to administer the message letter, and for example, includes a number of participants display field 61 and a page number display field 62, as illustrated in FIG. 20.

The number of participants display field 61 is a field for displaying the number of persons currently participating in the message letter, and specifically, is a field for displaying the number of persons who have answered the question so far (that is, answerers who have input information corresponding to the answer contents information in FIG. 10). The page number display field 62 is a field for displaying the page number of the message letter in the booklet format in the case of reflecting the currently collected messages.

Processing relevant to the administration screen is any processing, and for example, in a case where the user who is the organizer at any timing (for example, a timing before the deadline of the message, or the like) performs a predetermined manipulation for displaying the administration screen by designating the message letter of which the organizer is the user, the administration unit 232 of the server device 2 performs the following processing.

Specifically, with reference to the answer related information in FIG. 10, “B1”, “B2”, “B3”, and the like, which are the answerer information stored in association with “IDb001” that is an identification ID for identifying the message letter designated by the user, are counted, and the counting result is displayed in the number of participants display field 61 of FIG. 20, as the number of persons currently participating in the message letter. Then, the page number of the message written page is calculated by performing predetermined calculation based on the counting result (“Counting Result”÷“6” (a value corresponding to the number of persons posted on one message written page)), the page number of the other page (a page of which the page number is set in advance, such as the cover display page and the question written page) is added to the calculated page number of the message written page, and the addition result is displayed in the page number display field 62, as the page number of the message letter in the booklet format in the case of reflecting the currently collected messages.

### Administration Screen (Part 2)

In addition, not only the information described in “(Administration Screen (Part 1))” but also the other information (for example, the information indicating the deadline, the information indicating the question, and the like) may be displayed on the administration screen in FIG. 20.

### Characteristics

In addition, the characteristics of the embodiment described above and the characteristics of the modification example may be arbitrarily combined.

One embodiment of the present invention provides a generation system for generating a message letter displaying a message to a recipient from a plurality of target persons, the system comprising: an acquisition unit acquiring message information from the plurality of target persons, the message information indicating the message to the recipient; and an administration unit generating message letter information indicating the message letter, on the basis of the message information acquired by the acquisition unit, wherein the acquisition unit performs: first processing of displaying a question for inputting the message to the recipient as an answer on a side of the plurality of target persons; and second processing of acquiring answer information indicating the answer to the question displayed by the first processing, the answer being input to the generation system by the plurality of target persons, as the message information.

According to this embodiment, by displaying the question for inputting the message as an answer, and acquiring the answer information indicating the answer to the displayed question as the message information, for example, it is possible to consider the contents of the message in a format such as the answer to the question, and thus, it is possible to reduce a burden of considering the contents of the message, and it is possible to easily generate the message letter.

Another embodiment of the present invention provides the generation system according to the above embodiment, wherein in the first processing, the acquisition unit displays a pre-created question created in advance, or an administrator-created question created by an administrator administering the generation of the message letter.

According to this embodiment, by displaying the pre-created question or the administrator-created question, for example, it is possible to display the question by reducing a burden of considering the question or to display the question by reflecting the intention of the administrator, and thus, it is possible to easily generate the message letter.

Another embodiment of the present invention provides the generation system according to the above embodiment, wherein the pre-created question is sorted in accordance with the type of message letter, and when the type of message letter is designated by the administrator, the acquisition unit displays the pre-created question corresponding to the type of designated message letter, in the first processing.

According to this embodiment, by displaying the pre-created question corresponding to the type of message letter, for example, it is possible to display a suitable question, and thus, it is possible to suitably generate the message letter.

Another embodiment of the present invention provides the generation system according to the above embodiment, wherein the administration unit generates the message letter information indicating the message letter in a booklet format including a plurality of pages including at least a page corresponding to a cover, and a page displaying the message to the recipient.

According to this embodiment, by generating the message letter information indicating the message letter in the booklet format including the plurality of pages, for example, it is possible to generate the message letter in the booklet format, which is capable of suitably displaying a plurality of messages.

Another embodiment of the present invention provides the generation system according to the above embodiment, wherein the administration unit performs processing for providing the message letter to a receiver, as a bound booklet, a downloadable file in a predetermined format, or browsable information that can be browsed, on the basis of the message letter information.

According to this embodiment, by performing the processing for providing the message letter to the receiver as the bound booklet, the downloadable file in the predetermined format, or the browsable information that can be browsed, for example, it is possible to provide the message letter in a format according to the needs of the receiver.

Another embodiment of the present invention provides the generation system according to the above embodiment, wherein the administration unit performs processing for providing the message letter to the receiver, as browsable information that can be browsed at least until a browsing term, on the basis of the message letter information, and the administration unit extends the browsing term, on the basis of a request from the receiver.

According to this embodiment, by extending the browsing term, on the basis of the request from the receiver, for example, it is possible to make the browsing available until a time desired by the receiver.

Another embodiment of the present invention provides a generation program for generating a message letter displaying a message to a recipient from a plurality of target persons, the program allowing a computer to function as: an acquisition unit acquiring message information from the plurality of target persons, the message information indicating the message to the recipient; and an administration unit generating message letter information indicating the message letter, on the basis of the message information acquired by the acquisition unit, wherein the acquisition unit performs: first processing of displaying a question for inputting the message to the recipient as an answer on a side of the plurality of target persons; and second processing of acquiring answer information indicating the answer to the question displayed by the first processing, the answer being input to the computer by the plurality of target persons, as the message information.

According to this embodiment, by displaying the question for inputting the message as an answer, and acquiring the answer information indicating the answer to the displayed question as the message information, for example, it is possible to consider the contents of the message in a format such as the answer to the question, and thus, it is possible to reduce a burden of considering the contents of the message, and it is possible to easily generate the message letter.

### REFERENCE SIGNS LIST

1: terminal device
2: server device
11: communication unit
12: touch pad
13: display
14: recording unit
15: control unit
21: communication unit
22: recording unit
23: control unit
61: number of participants display field
62: page number display field
71: answerer name input field
72: question display field
73: answer input field
74: free message input field
81: recipient name input field
82: category input field
83: question input field
84: deadline input field
91: in-booklet question display field
92: in-booklet individual message field
100: information processing system
221: member information DB
222: question related information DB
223: setting information DB
224: answer related information DB
225: browsing related information DB
231: acquisition unit
232: administration unit
721: question display field
722: question display field
723: question display field
731: answer input field
732: answer input field
733: answer input field
831: question input field
832: question input field
833: question input field
921: image display field
922: name display field
923: message display field

1. A generation system for generating a message letter displaying a message to a recipient from a plurality of target persons, the system comprising:
an acquisition unit acquiring message information from the plurality of target persons, the message information indicating the message to the recipient; and
an administration unit generating message letter information indicating the message letter, on the basis of the message information acquired by the acquisition unit,
wherein the acquisition unit performs:
first processing of displaying a question for inputting the message to the recipient as an answer on a side of the plurality of target persons; and
second processing of acquiring answer information indicating the answer to the question displayed by the first processing, the answer being input to the generation system by the plurality of target persons, as the message information.

2. The generation system according to claim 1,
wherein in the first processing, the acquisition unit displays a pre-created question created in advance, or an administrator-created question created by an administrator administering the generation of the message letter.

3. The generation system according to claim 2,
wherein the pre-created question is sorted in accordance with the type of message letter, and
when the type of message letter is designated by the administrator, the acquisition unit displays the pre-created question corresponding to the type of designated message letter, in the first processing.

4. The generation system according to claim 1,
wherein the administration unit generates the message letter information indicating the message letter in a booklet format including a plurality of pages including at least a page corresponding to a cover, and a page displaying the message to the recipient.

5. The generation system according to claim 1,
wherein the administration unit performs processing for providing the message letter to a receiver, as a bound booklet, a downloadable file in a predetermined format, or browsable information that can be browsed, on the basis of the message letter information.

6. The generation system according to claim 1,
wherein the administration unit performs processing for providing the message letter to the receiver, as browsable information that can be browsed at least until a browsing term, on the basis of the message letter information, and
the administration unit extends the browsing term, on the basis of a request from the receiver.

7. A generation program for generating a message letter displaying a message to a recipient from a plurality of target persons, the program allowing a computer to function as:
an acquisition unit acquiring message information from the plurality of target persons, the message information indicating the message to the recipient; and
an administration unit generating message letter information indicating the message letter, on the basis of the message information acquired by the acquisition unit,
wherein the acquisition unit performs:
first processing of displaying a question for inputting the message to the recipient as an answer on a side of the plurality of target persons; and
second processing of acquiring answer information indicating the answer to the question displayed by the first processing, the answer being input to the computer by the plurality of target persons, as the message information.
